(19) United States
(12) Patent Application Publication
(10) Pub. No.: US 2008/0195697 A1
(43) Pub. Date: Aug. 14, 2008

(54) DATA RECEPTION APPARATUS OF CONSUMER ELECTRONICS DEVICE, METHOD THEREOF, DATA REPRODUCTION METHOD, AND CONSUMER ELECTRONICS DEVICE

(75) Inventor: Tae-jeoung KIM, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/861,654

(22) Filed: Sep. 26, 2007

(30) Foreign Application Priority Data
Feb. 13, 2007 (KR) 10-2007-0015099

(51) Int. Cl. G06F 15/16; G06F 21/00

(52) U.S. Cl. 709/203; 726/4

(57) ABSTRACT

A data reception apparatus of a consumer electronics (CE) device, a method thereof, a data reproduction method, and a CE device are provided. The data reception method includes connecting the CE device to an Internet server; receiving a CE device list and a content list of CE devices connected to the Internet server; selecting at least one content based on the CE device list and the content list; requesting at least one CE device having the selected contents to transmit the contents; and receiving the contents from the requested CE devices.

### CROSS-REFERENCE TO RELATED PATENT APPLICATION

This application claims priority from Korean Patent Application No. 10-2007-0015099, filed on Feb. 13, 2007 in the Korean Intellectual Property Office, the disclosure of which is incorporated herein in its entirety by reference.

### BACKGROUND OF THE INVENTION

1. Field of the Invention

he present invention relates to a data reception apparatus of a consumer electronics (CE) device, a method thereof, a data reproduction method, and a CE device.

2. Description of the Related Art

A peer-to-peer (P2P) method is a different method of sharing data compared to a related art server-client method in which services, such as distribution of contents formed of various multimedia data and downloading of the contents, are provided to a user from a server provided by a certain content provider (CP) by using the user's personal computer (PC). In the above-described server-client method, providers and users are completely separated. If a large number of clients desire to use the server, a data bottleneck occurs, and thus a server system may become overloaded. Since service quality such as transmission speed depends on the capability of the server, when the server has a problem, all clients connected to the server may not be effectively or efficiently provided with the services.

On the other hand, unlike the related art method in which desired information on the Internet is searched for by using a searching engine and then is downloaded from a server database, the P2P method directly provides the desired information from one PC to another PC connected to the Internet, and thus a user may search other PCs for data and download the data directly from the other PCs. In the P2P method, data is transmitted and received among a plurality of PCs connected to the Internet, and thus a load may not be focused on one computer or server, and instead may be distributed.

FIG. 1 is a block diagram of a content transmission system among a plurality of PCs used in a related art P2P method.

Referring to FIG. 1, a content server 110 connects contents stored in a plurality of client PCs 120. The content server 110 is connected to servers of the client PCs 120 and thereby manages distributed multimedia contents. The content server 110 receives a request for desired content from a receiving client PC and searches servers of providing client PCs for the desired content. When the content has been found, the content server 110 transfers information on a server of a providing client PC to the receiving client PC so that the receiving client PC may receive the content directly from the server of the providing client PC.

However, in this case, if a plurality of receiving client PCs want to receive a certain content of the server of the providing client PC, a priority problem may occur and fast receiving of the content may not be performed. Furthermore, the content server 110 has to manage the server of the providing client PC having the content, search the server of the providing client PC for the content upon request, and provide the search result to the receiving client PC. As a result, a network access overload may occur, and CE devices having lower performances than PCs may not reproduce desired content efficiently.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a data reception apparatus of a CE device, and a method thereof, enabling efficient content transmission among a plurality of CE devices.

The present invention also provides a data reception apparatus of a CE device, and a method thereof, capable of minimizing a network load of a server by utilizing maximum resources of a CE device.

According to an aspect of the present invention, there is provided a data reception method of a CE device, the method including connecting the CE device to an Internet server; receiving a CE device list and a content list of CE devices connected to the Internet server; selecting at least one content based on the CE device list and the content list; requesting at least one CE device having the selected contents to transmit the contents; and receiving the contents from the requested CE devices.

The connecting of the CE device to the Internet server and the receiving of the CE device list and the content list of the CE devices connected to the Internet server may include connecting the CE device to the Internet server and obtaining authorization of the CE device; requesting the CE device list and the content list of the CE devices connected to the Internet server; and receiving the CE device list and the content list.

The requesting of the at least one CE device having the selected contents to transmit the contents may include sorting the CE devices having the selected contents based on a content transmission speed; and requesting the CE devices to transmit the contents based on the sorted order.

The requesting of the at least one CE device having the selected contents to transmit the contents may include determining a number of packets of the selected contents; and requesting the CE devices having the contents to transmit the determined packets. The receiving of the contents from the requested CE devices may include receiving the contents packet by packet.

The requesting of the CE devices having the contents to transmit the determined packets may include sorting the CE devices based on a packet transmission speed for each packet; and requesting the CE devices to transmit the packets based on the sorted order.

The CE device list may include IP addresses and port numbers of the CE devices connected to the Internet server.

According to another aspect of the present invention, there is provided a data reception method of a CE device, the method including connecting the CE device to an Internet server; requesting the Internet server for information on desired content; receiving a CE device list of CE devices having the content; requesting at least one CE device for the content based on the received CE device list; and receiving the content from the requested CE devices.

The requesting of the at least one CE device for the content based on the received CE device list may include sorting the CE devices based on a content transmission speed; and requesting the CE devices to transmit the content based on the sorted order.

The requesting of the at least one CE device for the content based on the received CE device list may include determining a number of packets of the content; sorting the CE devices based on a packet transmission speed for each packet; and requesting the CE devices to transmit the packets based on the sorted order. The receiving of the content from the requested CE devices may include receiving the content packet by packet.

The CE device list may include IP addresses and port numbers of the CE devices connected to the Internet server.

According to another aspect of the present invention, there is provided a data reception apparatus of a CE device, the apparatus including a server interface unit which connects the CE device to an Internet server and receives a CE device list and a content list of CE devices connected to the Internet server; a content selection unit which selects at least one content based on the CE device list and the content list; a content request unit which requests at least one CE device having the selected contents to transmit the contents; and a data reception unit which receives the contents from the requested CE devices.

The server interface unit may include a server connection unit which connects the CE device to the Internet server and obtains authorization of the CE device; a server request unit which requests the CE device list and the content list of the CE devices connected to the Internet server; and a server reception unit which receives the CE device list and the content list requested by the server request unit.

The content request unit may include a sorting unit which sorts the CE devices having the selected contents based on content transmission speed; and a data request unit which requests the CE devices to transmit the contents based on the sorted order.

The content request unit may further include a packet determination unit which determines a number of packets of the selected contents, the data request unit may request the CE devices having the contents to transmit the determined packets, and the data reception unit may receive the contents packet by packet.

The sorting unit may sort the CE devices based on packet transmission speed for each packet; and the data request unit may request the CE devices to transmit the packets based on the sorted order.

The CE device list may include IP addresses and port numbers of the CE devices connected to the Internet server.

According to another aspect of the present invention, there is provided a data reception apparatus of a CE device, the apparatus including a server request unit which connects the CE device to an Internet server and requests the Internet server for information on desired content; a server reception unit which receives a CE device list of CE devices having the content; a content request unit which requests at least one CE device for the content based on the received CE device list; and a data reception unit which receives the content from the requested CE devices.

The content request unit may include a sorting unit which sorts the CE devices based on a content transmission speed; and a data request unit which requests the CE devices to transmit the content based on the sorted order.

The content request unit may include a packet determination unit which determines a number of packets of the content; a sorting unit which sorts the CE devices based on a packet transmission speed for each packet; and a data request unit which requests the CE devices to transmit the packets based on the sorted order. The data reception unit may receive the content packet by packet.

According to another aspect of the present invention, there is provided a data reproduction method of a CE device, the method including connecting the CE device to an Internet server; receiving a CE device list and a content list of CE devices connected to the Internet server; selecting at least one content based on the CE device list and the content list; requesting at least one CE device having the selected contents to transmit the contents; receiving the contents from the requested CE devices; and reproducing the received contents.

The requesting of the at least one CE device having the selected contents to transmit the contents may include determining a number of packets of the selected contents; and requesting the CE devices having the contents to transmit the determined packets. The receiving of the contents from the requested CE devices may include receiving the contents packet by packet, and the reproducing of the received contents may include sorting the received packets and reproducing the packets in the sorted order.

The requesting of the at least one CE device having the selected contents to transmit the contents may further include allocating numbers to the packets after the determining of the number of packets of the selected contents. The sorting the received packets may be based on the allocated numbers.

According to another aspect of the present invention, there is provided a CE device, the device including a server interface unit which connects the CE device to an Internet server and receives a CE device list and a content list of CE devices connected to the Internet server; a content selection unit which selects at least one content based on the CE device list and the content list; a content request unit which requests at least one CE device having the selected contents to transmit the contents; a data reception unit which receives the contents from the requested CE devices; and a content reproduction unit which reproduces the received contents.

The content request unit may include a packet determination unit which determines a number of packets of the selected contents, the content request unit may request the CE devices having the contents to transmit the determined packets, the data reception unit may receive the contents packet by packet, and the content reproduction unit may sort the received packets and reproduce the packets in the sorted order.

The packet determination unit may allocate numbers to the packets of the contents, and the content reproduction unit may sort the received packets based on the allocated numbers.

According to another aspect of the present invention, there is provided a computer readable recording medium having recorded thereon a computer program for executing a data reception method of a CE device, the method including connecting the CE device to an Internet server; receiving a CE device list and a content list of CE devices connected to the Internet server; selecting at least one content based on the CE device list and the content list; requesting at least one CE device having the selected contents to transmit the contents; and receiving the contents from the requested CE devices.

According to another aspect of the present invention, there is provided a computer readable recording medium having recorded thereon a computer program for executing a data reception method of a CE device, the method including connecting the CE device to an Internet server; requesting the Internet server for information on desired content; receiving a CE device list of CE devices having the content; requesting at least one CE device for the content based on the received CE device list; and receiving the content from the requested CE devices.

According to another aspect of the present invention, there is provided a computer readable recording medium having recorded thereon a computer program for executing a data reproduction method of a CE device, the method including connecting the CE device to an Internet server; receiving a CE device list and a content list of CE devices connected to the Internet server; selecting at least one content based on the CE device list and the content list; requesting at least one CE device having the selected contents to transmit the contents; receiving the contents from the requested CE devices; and reproducing the received contents.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram of a related art content transmission system among a plurality of PCs;

FIG. 2A is a block diagram of a data reception apparatus of a CE device, according to an exemplary embodiment of the present invention;

FIG. 2B is a detailed block diagram of the data reception apparatus illustrated in FIG. 2A, according to an exemplary embodiment of the present invention;

FIG. 3 is a block diagram of a data reception apparatus of a CE device, according to another exemplary embodiment of the present invention;

FIG. 4 is a reference view for describing a data transmission method among a plurality of CE devices, according to an exemplary embodiment of the present invention;

FIG. 5 is a flowchart of a data reception method of a CE device, according to an exemplary embodiment of the present invention;

FIG. 6 is a detailed flowchart of a data reception method of a CE device, according to an exemplary embodiment of the present invention;

FIG. 7 is a detailed flowchart of a data reception method of a CE device, according to another exemplary embodiment of the present invention;

FIG. 8 is a reference view for describing a data transmission method, according to an exemplary embodiment of the present invention;

FIG. 9 is a block diagram of a CE device, according to an exemplary embodiment of the present invention; and

FIG. 10 is a flowchart of a data reproduction method, according to an exemplary embodiment of the present invention.

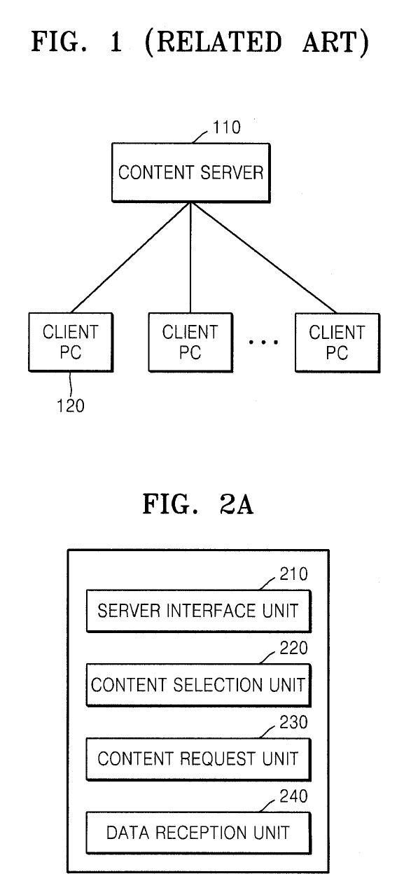

### DETAILED DESCRIPTION OF EXEMPLARY EMBODIMENTS OF THE INVENTION

Hereinafter, the present invention will be described in detail by explaining exemplary embodiments of the invention with reference to the attached drawings.

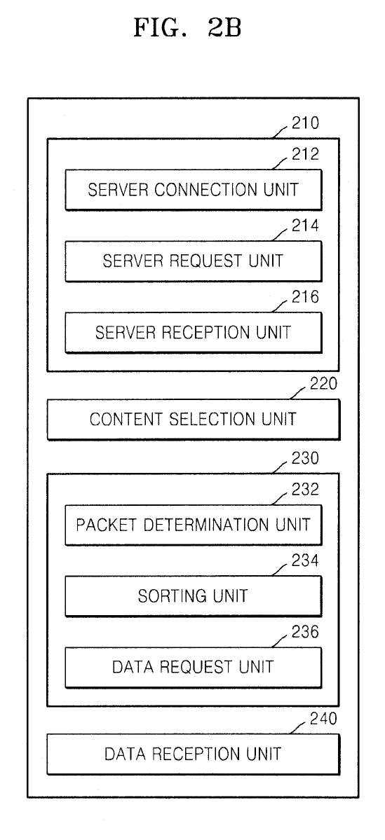

FIG. 2A is a block diagram of a data reception apparatus of a CE device, according to an exemplary embodiment of the present invention.

Referring to FIG. 2A, the data reception apparatus includes a server interface unit 210, a content selection unit 220, a content request unit 230, and a data reception unit 240. In exemplary embodiments of the present invention, CE devices include all data reception terminals except for PCs, such as IP televisions (IPTVs), digital versatile disc (DVD) players, Photo frames like silicon on double insulators (SODIs), and mobile phones.

The server interface unit 210 connects the CE device to an Internet server, and receives a CE device list and a content list of CE devices connected to the Internet server. The Internet server manages information on connectable CE devices in the form of a table. The information of the table includes IP addresses and port numbers of the connected CE devices. In order for CE devices connected to a local network implemented in an office or home to be connected to the Internet server, an identical IP address and port number have to be allocated to each CE device. The CE device needs to receive such information of another CE device for connection.

The content selection unit 220 selects desired content based on the CE device list and the content list received by the server interface unit 210 from the Internet server. The content request unit 230 directly requests other CE devices having desired content to send the content without connecting to the Internet server. As such, overload of the Internet server may be prevented and the content may be transmitted quickly.

The data reception unit 240 receives the content directly from the requested CE devices.

FIG. 2B is a detailed block diagram of the data reception apparatus illustrated in FIG. 2A, according to an exemplary embodiment of the present invention.

Referring to FIG. 2B, the data reception apparatus includes a server interface unit 210, a content selection unit 220, a content request unit 230, and a data reception unit 240. The server interface unit 210 includes a server connection unit 212, a server request unit 214, and a server reception unit 216. The content request unit 230 includes a packet determination unit 232, a sorting unit 234, and a data request unit 236.

The server connection unit 212 of the server interface unit 210 connects a CE device to an Internet server and obtains authorization of the CE device. Authorization is being accepted as one of a plurality of devices managed by the Internet server. If only the Internet server authorizes the CE device, the CE device may be provided information from the Internet server.

The server request unit 214 requests a CE device list and a content list of CE devices connected to the Internet server. The Internet server provides the CE device list, including channel titles of the CE devices, globally unique identifiers (GUIDs), and information on locations of original contents, to the CE device. The server reception unit 216 receives the CE device list and the content list requested by the server request unit 214. The CE device list includes information on IP addresses and port numbers of the CE devices.

The content selection unit 220 selects desired content from among the content list received by the server reception unit 216. The packet determination unit 232 of the content request unit 230 determines the number of packets of the selected content. A packet is a unit of data transmission, and the content is transmitted or received packet by packet. Data is not continuously transmitted from a providing CE device to a receiving CE device. The data to be transmitted is divided into a plurality of data pieces, the data pieces are formed into packets, and the packets are transmitted one by one. Before the transmission, a data transmission unit has to be determined, and the number of packets also has to be determined. The size of the packets of the content to be received may have already been determined in the CE device, or may be re-determined by the packet determination unit 232.

The sorting unit 234 sorts CE devices having the packets based on packet transmission speed for each of the packets determined by the packet determination unit 232. Due to different network transmission speeds of the CE devices, each packet included in a CE device having the fastest transmission speed may be received first by sorting the CE devices. As such, the packets may be received from different CE devices. The data request unit 236 requests the CE devices to transmit the packets based on the order sorted by the sorting unit 234. The CE devices are requested based on the sorted order to receive each packet included in a CE device having the fastest transmission speed.

The data reception unit 240 receives the data from the requested CE devices packet by packet. Since the packets may be received from the different CE devices, the received packets have to form content before reproducing the content.

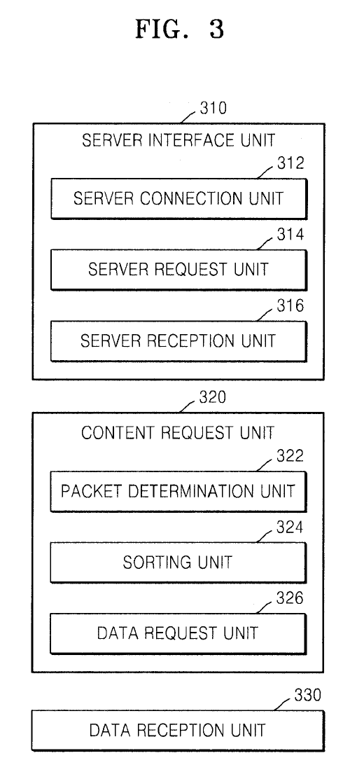

FIG. 3 is a block diagram of a data reception apparatus of a CE device, according to another exemplary embodiment of the present invention.

Referring to FIG. 3, the data reception apparatus includes a server interface unit 310, a content request unit 320, and a data reception unit 330. The server interface unit 310 includes a server connection unit 312, a server request unit 314, and a server reception unit 316. The content request unit 320 includes a packet determination unit 322, a sorting unit 324, and a data request unit 326.

The server connection unit 312 of the server interface unit 310 connects a CE device to an Internet server and obtains authorization of the CE device. The server request unit 314 requests a CE device list and a content list of CE devices connected to the Internet server. The server reception unit 316 receives the CE device list and the content list requested by the server request unit 314. The CE device list includes information on IP addresses and port numbers of the CE devices.

The packet determination unit 322 of the content request unit 320 determines the number of packets of the selected content. The size of the packets of the content to be received may have been determined in the CE device, or may be re-determined by the packet determination unit 322.

The sorting unit 324 sorts CE devices having the packets based on a packet transmission speed for each of the packets determined by the packet determination unit 322. Due to different network transmission speeds of the CE devices, a packet included in a CE device having the fastest transmission speed may be received first by sorting the CE devices. The data request unit 326 requests the CE devices to transmit the packets based on the order sorted by the sorting unit 324. The data reception unit 330 receives the data from the requested CE devices packet by packet.

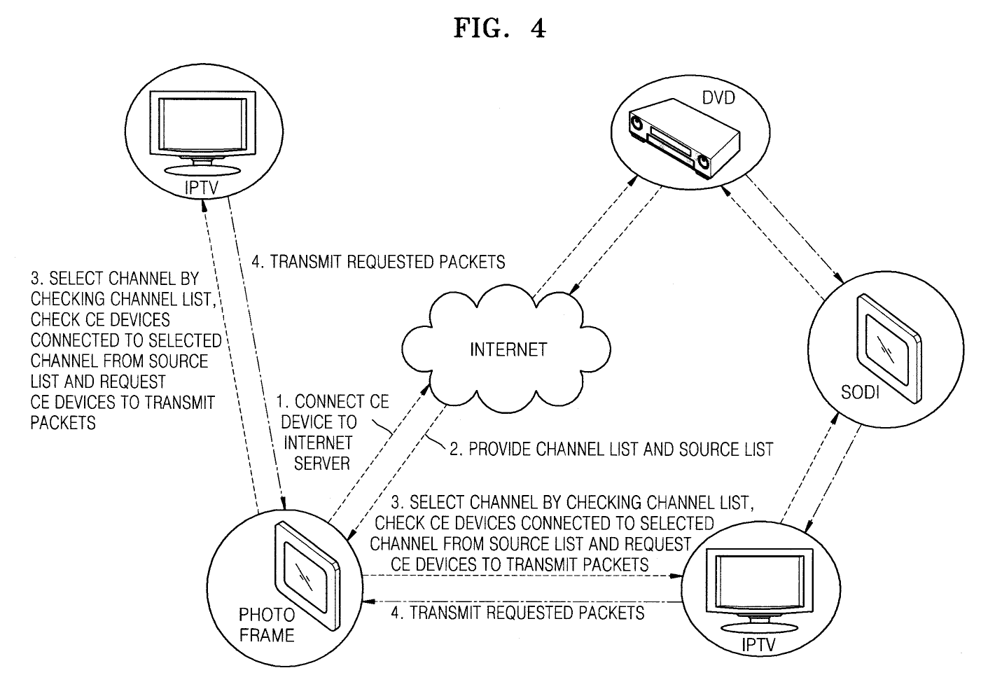

FIG. 4 is a reference view for describing a data transmission method among a plurality of CE devices, according to an exemplary embodiment of the present invention.

An Internet server manages a plurality of CE devices such as IPTVs, Photo frames, and DVD players.

Referring to FIG. 4, a Photo frame on the bottom left, which is a receiving CE device required to receive content, is connected to an Internet server. Then, the Photo frame receives a channel list (a content list) and a source list (a CE device list) from the Internet server. The Photo frame checks the lists and requests IPTVs, which are providing CE devices which have a desired content, to transmit packets. The IPTVs provide the requested packets to the Photo frame.

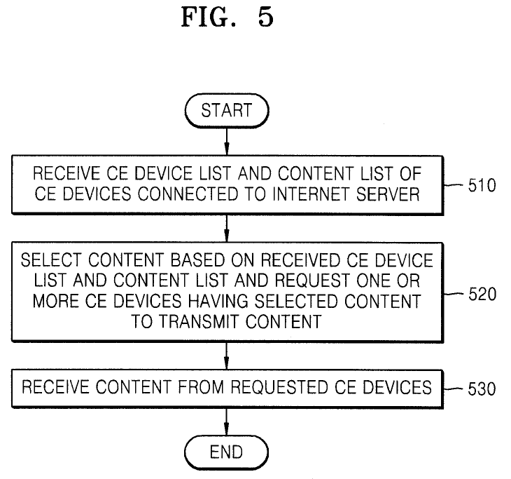

FIG. 5 is a flowchart of a data reception method of a CE device, according to an exemplary embodiment of the present invention.

Referring to FIG. 5, in operation 510, a CE device list and a content list of CE devices connected to an Internet server are received. For this, a CE device has to be connected to the Internet server, and request the internet server for the CE device list and the content list of contents included by the CE devices. Also, the Internet server has to manage the connected CE devices and have information on IP addresses and channel titles of the CE devices.

In operation 520, content is selected based on the CE device list and the content list received from the Internet server, and at least one CE device having the selected content is requested to transmit the content. Reproduction of streaming data, which can be transmitted and reproduced in real time, is enabled by a CE device as well as a PC. A large amount of the stream data may be guaranteed in a short time by requesting a plurality of CE devices which reproduce or use corresponding content for content transmission, instead of requesting an Internet server which manages contents.

In operation 530, the content is received from the requested CE devices.

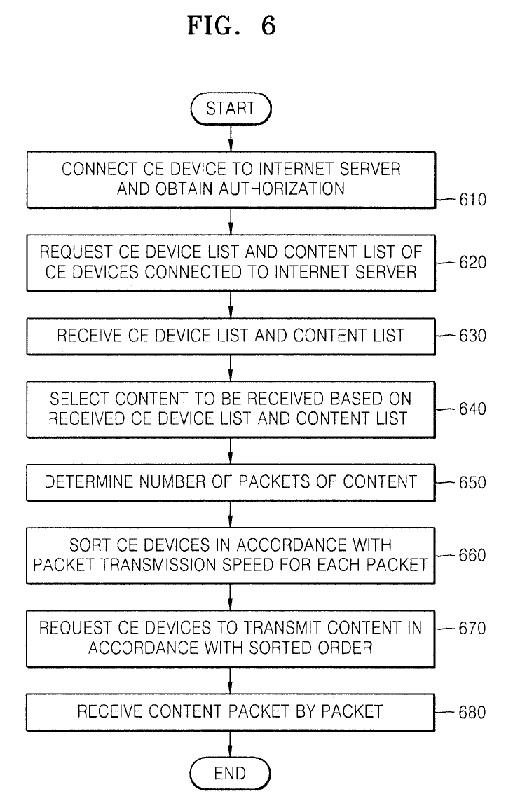

FIG. 6 is a detailed flowchart of a data reception method of a CE device, according to an exemplary embodiment of the present invention.

Referring to FIG. 6, in operation 610, a receiving CE device required to receive data is connected to an Internet server and authorization of the CE device is obtained. The Internet server authorizes the CE device if the CE device is one of devices managed by the Internet server, and then the CE device may be provided information from the Internet server.

In operation 620, if the authorization is obtained in operation 610, a CE device list and a content list of CE devices connected to the Internet server are requested. In operation 630, the CE device list and the content list are received. The Internet server manages information on connectable CE devices in the form of a table. The information of the table includes IP addresses and port numbers of the connected CE devices. The receiving CE device may be directly connected to providing CE devices by using the information included in the CE device list.

In operation 640, content is selected based on the CE device list and the content list received from the Internet server. In operation 650, the number of packets of the content selected in operation 640 is determined. A packet is a unit of data transmission. The receiving CE device does not receive data continuously, but divides the data into a plurality of packets and receives the data transmitted packet by packet. Also, the packets may be received from different CE devices. For this, before requesting data transmission, a data transmission unit has to be determined and the number of packets also has to be determined. The size of the packets of the content to be received may have been determined in the receiving CE device, or may be re-determined before receiving the packets.

In operation 660, CE devices having the packets are sorted based on packet transmission speed. Due to different network transmission speeds of the CE devices, each packet included in a CE device having the fastest transmission speed may be received first by sorting the CE devices. As such, the packets may be received from different CE devices.

In operation 670, the CE devices are requested based on the sorted order to transmit the packets. By requesting a CE device having the fastest transmission speed of a corresponding packet to transmit the packet with priority, the data may be transmitted quickly. If the requested CE device refuses to transmit the packet due to a restricted number of circuit lines, or transmits the packet slowly due to changes of transmission speed, a next CE device may be requested to transmit the packet based on the sorted order.

In operation 680, the content is received packet by packet.

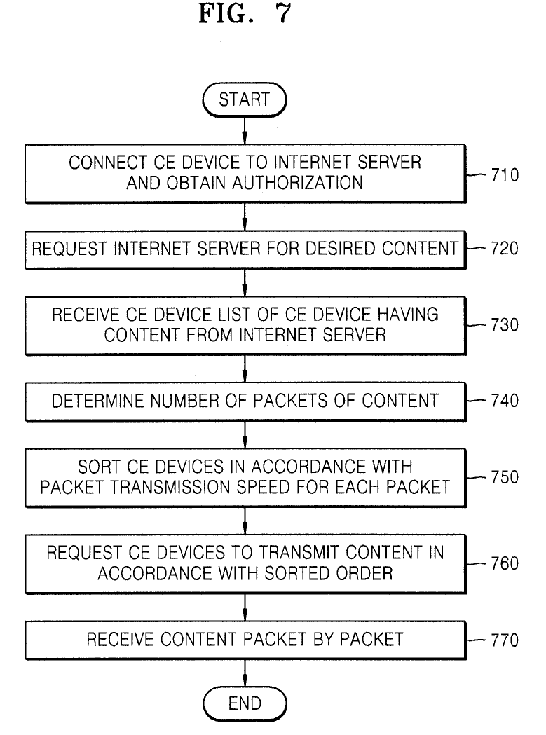

FIG. 7 is a detailed flowchart of a data reception method of a CE device, according to another exemplary embodiment of the present invention.

According to the current exemplary embodiment, a receiving CE device determines desired content in advance and requests an Internet server for the content. Information on the content is received from the Internet server and the receiving CE device is directly connected to a providing CE device.

Referring to FIG. 7, in operation 710, a receiving CE device is connected to an Internet server and authorization of the CE device is obtained. If authorized, in operation 720, the CE device requests the Internet server for desired content.

In operation 730, a CE device list of CE devices having the content is received from the Internet server. In order to receive the content directly from different CE devices, information on IP addresses and port numbers of the CE devices is also received.

In operation 740, the number of packets of the content to be received from the CE devices is determined. The content is divided into a plurality of packets, and the size and number of packets are determined.

In operation 750, the CE devices having the packets are sorted based on packet transmission speed. In operation 760, the CE devices are requested based on the sorted order to transmit the packets. For each packet, a CE device having the fastest transmission speed of the packet is requested with priority. If the requested CE device refuses to transmit the packet due to a restricted number of circuit lines, or transmits the packet slowly due to changes of transmission speed, a next CE device may be requested to transmit the packet based on the sorted order.

In operation 770, the content is received from the CE devices packet by packet.

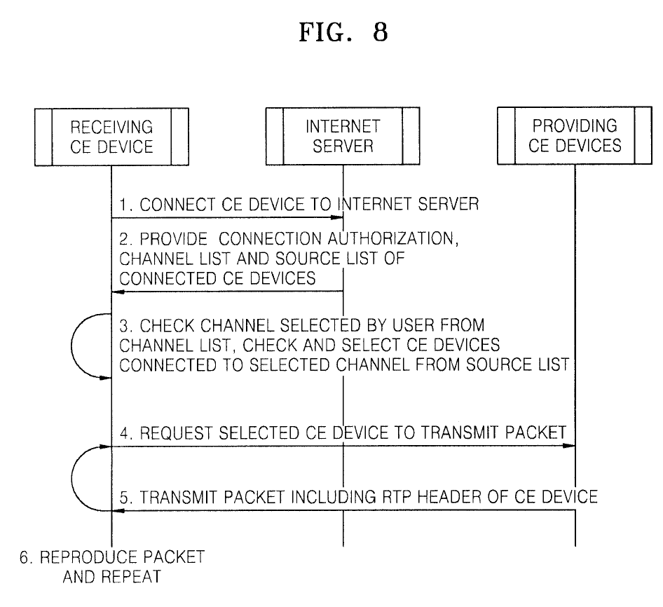

FIG. 8 is a reference view for describing a data transmission method, according to an exemplary embodiment of the present invention.

Referring to FIG. 8, a receiving CE device required to receive data is connected to an Internet server. The Internet server authorizes the receiving CE device and provides a channel list (a content list) and a source list (a providing CE device list) to the receiving CE device. The receiving CE device checks and selects a channel selected by a user from the channel list and CE devices having the channel from the source list. In this case, the selected CE device may be determined by an order of fast network transmission speed.

Then, the receiving CE device directly requests one of the selected providing CE devices to transmit a data packet. Since the content is transmitted in data packets and the data packets may be transmitted from different providing CE devices, the receiving CE device may request different providing CE devices for each data packet. The requested providing CE device transmits the data packet, including real time protocol (RTP) headers of the requested CE device. The RTP header is used for synchronizing with the receiving CE device. The received data packet is reproduced and the receiving CE device requests a next data packet. The requesting and reproducing of the data packets are repeated until all data packets of the selected content are received and reproduced.

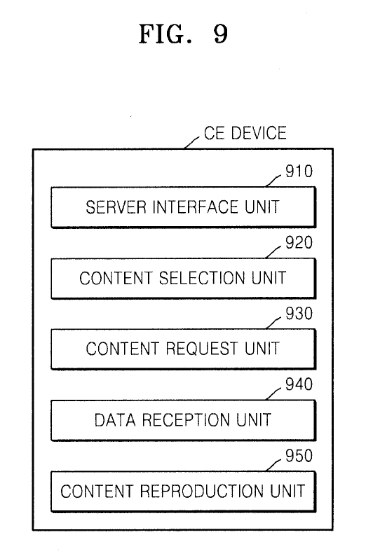

FIG. 9 is a block diagram of a CE device, according to an exemplary embodiment of the present invention.

Referring to FIG. 9, the CE device includes a server interface unit 910, a content selection unit 920, a content request unit 930, a data reception unit 940, and a content reproduction unit 950. In exemplary embodiments of the present invention, CE devices include all data reception terminals except for PCs, such as IPTVs, DVD players, Photo frames like SODIs, and mobile phones.

The server interface unit 910 connects the CE device to an Internet server, and receives a CE device list and a content list of CE devices connected to the Internet server. The Internet server manages information on connectable CE devices in the form of a table. The information of the table includes IP addresses and port numbers of the connected CE devices.

The content selection unit 920 selects desired content based on the CE device list and the content list received by the server interface unit 910 from the Internet server. The content request unit 930 directly requests other CE devices having desired content for the content without connecting to the Internet server. As such, the overload of the Internet server may be prevented and the content may be transmitted quickly. The content request unit 930 determines the number of packets of the selected content, allocates numbers to the packets, and requests the other CE devices having the packets to transmit the packets.

The data reception unit 940 receives the content directly from the requested CE devices. Here, the content is received packet by packet.

The content reproduction unit 950 sorts the received packets based on the allocated numbers and reproduces the packets in the sorted order.

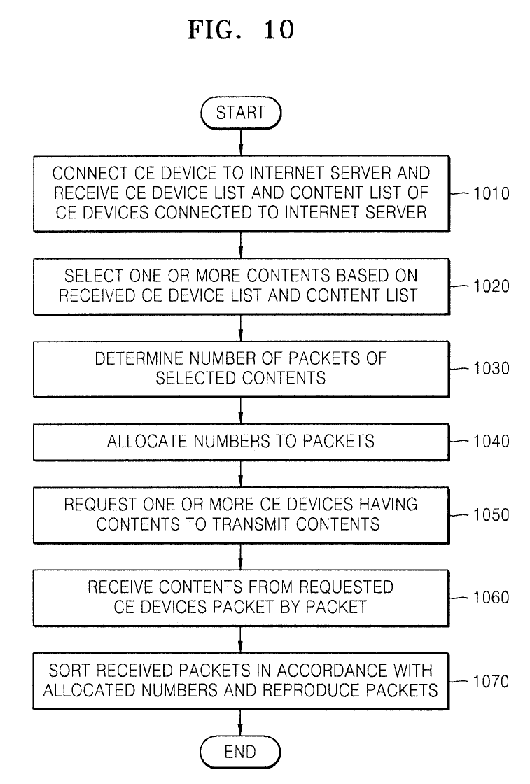

FIG. 10 is a flowchart of a data reproduction method, according to an exemplary embodiment of the present invention.

Referring to FIG. 10, in operation 1010, a CE device is connected to an Internet server, and receives a CE device list and a content list of CE devices connected to the Internet server.

In operation 1020, desired content is selected based on the CE device list and the content list received from the Internet server. In operation 1030, the number of packets of the selected content is determined. A packet is a unit of data transmission, and data is divided into a plurality of packets in order to receive the data packet by packet.

In operation 1040, each of the packets is allocated a number in order to determine the reproduction order of the packets if the packets are received from different CE devices. In operation 1050, at least one CE device having the packets of the selected content are requested to transmit the content. Reproduction of streaming data which can be transmitted and reproduced in real time is enabled by a CE device as well as a PC. A large amount of the stream data may be guaranteed in a short time by requesting a plurality of CE devices which reproduce or use a corresponding content for content transmission, instead of requesting an Internet server which manages contents. A CE device having the fastest transmission speed of a corresponding packet may be requested to transmit the packet with priority.

In operation 1060, the content is received from the requested CE devices packet by packet. In operation 1070, the received packets are sorted based on the allocated numbers and are reproduced in the sorted order.

The exemplary embodiments of the present invention can be written as computer programs, and can be implemented in general-use digital computers that execute the programs using a computer readable recording medium. Examples of the computer readable recording medium include magnetic storage media (e.g., ROM, floppy disks, hard disks, etc.) and optical recording media (e.g., CD-ROMs, or DVDs.

As described above, according to exemplary embodiments of the present invention, content may be efficiently transmitted among a plurality of CE devices.

Furthermore, a network load on an Internet server may be minimized by utilizing maximum resources of a CE device, and the CE device may guarantee a sufficient amount of streaming data.

While the present invention has been particularly shown and described with reference to exemplary embodiments thereof, it will be understood by those of ordinary skill in the art that various changes in form and details may be made therein without departing from the spirit and scope of the invention as defined by the appended claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. A data reception method of a consumer electronics (CE) device, the method comprising:
connecting the CE device to an Internet server;
receiving a CE device list and a content list of CE devices connected to the Internet server;
selecting at least one content based on the CE device list and the content list;
requesting at least one CE device of the CE devices having the selected at least one content to transmit the selected at least one content; and
receiving the at least one content from the requested at least one CE device.

2. The method of claim 1, wherein the connecting of the CE device to the Internet server and the receiving of the CE device list and the content list of the CE devices connected to the Internet server comprises:
connecting the CE device to the Internet server and obtaining authorization of the CE device;
requesting the CE device list and the content list of the CE devices connected to the Internet server; and
receiving the CE device list and the content list.

3. The method of claim 2, wherein the requesting of the at least one CE device having the selected at least one content to transmit the at least one content comprises:
sorting the at least one CE device having the selected at least one content based on a content transmission speed; and
requesting the at least one CE device to transmit the selected at least one content based on the sorting.

4. The method of claim 2, wherein the requesting of the at least one CE device having the selected at least one content to transmit the at least one content comprises:
determining a number of packets of the selected at least one content; and
requesting the at least one CE device having the selected at least one content to transmit the determined packets;
wherein the receiving of the selected at least one content from the requested CE devices comprises receiving the selected at least one content packet by packet.

5. The method of claim 4, wherein the requesting of the at least one CE device having the selected at least one content to transmit the determined packets comprises:
sorting the at least one CE device based on a packet transmission speed for each of the packets; and
requesting the at least one CE device to transmit the packets based on the sorting.

6. The method of claim 2, wherein the CE device list includes Internet Protocol (IP) addresses and port numbers of the CE devices connected to the Internet server.

7. A data reception method of a consumer electronics (CE) device, the method comprising:
connecting the CE device to an Internet server;
requesting the Internet server for information on desired content;
receiving a CE device list of CE devices having the desired content;
requesting at least one CE device of the CE devices for the desired content based on the received CE device list; and
receiving the desired content from the requested at least one CE device.

8. The method of claim 7, wherein the requesting of the at least one CE device for the desired content based on the received CE device list comprises:
sorting the at least one CE device based on a content transmission speed; and
requesting the at least one CE device to transmit the desired content based on the sorting.

9. The method of claim 7, wherein the requesting of the at least one CE device for the desired content based on the received CE device list comprises:
determining a number of packets of the desired content;
sorting the at least one CE device based on a packet transmission speed for each of the packets; and
requesting the at least one CE device to transmit the packets based on the sorting;
wherein the receiving of the desired content from the requested at least one CE device comprises receiving the desired content packet by packet.

10. The method of claim 7, wherein the CE device list includes Internet Protocol (IP) addresses and port numbers of the CE devices connected to the Internet server.

11. A data reception apparatus of a consumer electronics (CE) device, the apparatus comprising:
a server interface unit which connects the CE device to an Internet server and receives a CE device list and a content list of CE devices connected to the Internet server;
a content selection unit which selects at least one content based on the CE device list and the content list;
a content request unit which requests at least one CE device having the selected at least one content to transmit the selected at least one content; and
a data reception unit which receives the selected at least one content from the requested at least one CE device.

12. The apparatus of claim 11, wherein the server interface unit comprises:
a server connection unit which connects the CE device to the Internet server and obtains authorization of the CE device;
a server request unit which requests the CE device list and the content list of the CE devices connected to the Internet server; and
a server reception unit which receives the CE device list and the content list requested by the server request unit.

13. The apparatus of claim 12, wherein the content request unit comprises:
a sorting unit which sorts the at least one CE device having the selected at least one content based on content transmission speed into a sorting order; and
a data request unit which requests the at least one CE device to transmit the selected at least one content based on the sorted order.

14. The apparatus of claim 12, wherein the content request unit further comprises a packet determination unit which determines a number of packets of the selected at least one content,
the data request unit requests the at least one CE device having the selected at least one content to transmit the determined packets, and
the data reception unit receives the selected at least one content packet by packet.

15. The apparatus of claim 13, wherein the sorting unit sorts the at least one CE device based on packet transmission speed for each of the packets; and
the data request unit requests the at least one CE device to transmit the packets based on the sorted order.

16. The apparatus of claim 12, wherein the CE device list includes Internet Protocol (IP) addresses and port numbers of the CE devices connected to the Internet server.

17. A data reception apparatus of a consumer electronics (CE) device, the apparatus comprising:
a server request unit which connects the CE device to an Internet server and requests the Internet server for information on desired content;
a server reception unit which receives a CE device list of CE devices having the desired content;
a content request unit which requests at least one CE device for the desired content based on the received CE device list; and
a data reception unit which receives the desired content from the requested at least one CE device.

18. The apparatus of claim 17, wherein the content request unit comprises:
a sorting unit which sorts the at least one CE device based on a content transmission speed into a sorting order; and
a data request unit which requests the at least one CE device to transmit the desired content based on the sorted order.

19. The apparatus of claim 17, wherein the content request unit comprises:
a packet determination unit which determines a number of packets of the desired content;
a sorting unit which sorts the at least one CE device based on a packet transmission speed for each of the packets; and
a data request unit which requests the at least one CE device to transmit the packets based on the sorted order;
wherein the data reception unit receives the desired content packet by packet.

20. A data reproduction method of a consumer electronics (CE) device, the method comprising:
connecting the CE device to an Internet server;
receiving a CE device list and a content list of CE devices connected to the Internet server;
selecting at least one content based on the CE device list and the content list;
requesting at least one CE device having the selected at least one content to transmit the selected at least one content;
receiving the selected at least one content from the requested at least one CE device; and
reproducing the received selected at least one content.

21. The method of claim 20, wherein the requesting of the at least one CE device having the selected at least one content to transmit the selected at least one content comprises:
determining a number of packets of the selected at least one content; and
requesting the at least one CE device having the selected at least one content to transmit the determined packets;
wherein the receiving of the selected at least one content from the requested at least one CE device comprises receiving the selected at least one content packet by packet, and
the reproducing of the received selected at least one content comprises sorting the received packets into a sorted order and reproducing the packets in the sorted order.

22. The method of claim 21, wherein the requesting of the at least one CE device having the selected at least one content to transmit the selected at least one content further comprises:
allocating numbers to the packets after the determining of the number of packets of the selected at least one content;
wherein the sorting the received packets is based on the allocated numbers.

23. A consumer electronics (CE) device, the device comprising:
a server interface unit which connects the CE device to an Internet server and receives a CE device list and a content list of CE devices connected to the Internet server;
a content selection unit which selects at least one content based on the CE device list and the content list;
a content request unit which requests at least one CE device having the selected at least one content to transmit the selected at least one content;
a data reception unit which receives the selected at least one content from the requested at least one CE device; and
a content reproduction unit which reproduces the received selected at least one content.

24. The device of claim 23, wherein the content request unit comprises a packet determination unit which determines a number of packets of the selected at least one content,
the content request unit requests the at least one CE device having the selected at least one content to transmit the determined packets,
the data reception unit receives the selected at least one content packet by packet, and
the content reproduction unit sorts the received packets into a sorted order and reproduces the packets in the sorted order.

25. The device of claim 24, wherein the packet determination unit allocates numbers to the packets of the selected at least one content, and
the content reproduction unit sorts the received packets based on the allocated numbers and reproduces the packets in the sorted order.

26. A computer readable recording medium having recorded thereon a computer program for executing a data reception method of a consumer electronics (CE) device, the method comprising:
connecting the CE device to an Internet server;
receiving a CE device list and a content list of CE devices connected to the Internet server;
selecting at least one content based on the CE device list and the content list;
requesting at least one CE device having the selected at least one content to transmit the selected at least one content; and
receiving the selected at least one content from the requested at least one CE device.

27. A computer readable recording medium having recorded thereon a computer program for executing a data reception method of a consumer electronics (CE) device, the method comprising:
connecting the CE device to an Internet server;
requesting the Internet server for information on desired content;
receiving a CE device list of CE devices having the desired content;
requesting at least one CE device for the desired content based on the received CE device list; and
receiving the desired content from the requested at least one CE device.

28. A computer readable recording medium having recorded thereon a computer program for executing a data reproduction method of a consumer electronics (CE) device, the method comprising:
connecting the CE device to an Internet server;
receiving a CE device list and a content list of CE devices connected to the Internet server;
selecting at least one content based on the CE device list and the content list;
requesting at least one CE device having the selected at least one content to transmit the selected at least one content;
receiving the selected at least one content from the requested at least one CE device; and
reproducing the received selected at least one content.
